(19) United States
(12) Patent Application Publication
(10) Pub. No.: US 2018/0359935 A1
(43) Pub. Date: Dec. 20, 2018

(54) FLOWER POT SAUCER WITH A DRAINAGE SYSTEM

(71) Applicant: John X. Stratton, Bettendorf, IA (US)

(72) Inventor: John X. Stratton, Bettendorf, IA (US)

(21) Appl. No.: 16/009,706

(22) Filed: Jun. 15, 2018

Related U.S. Application Data
(60) Provisional application No. 62/519,971, filed on Jun. 15, 2017.

(51) Int. Cl. A01G 9/04

(52) U.S. Cl. CPC A01G 9/047

(57) ABSTRACT

The present invention provides a flower pot saucer. The flower pot saucer includes a base with a sidewall extending upwardly therefrom. The base has an upper surface and a lower surface. An aperture is disposed in the base. A screen covers the aperture and is affixed to the upper surface of the base along the periphery of the aperture. In some embodiments, the screen covers the aperture and is affixed to the bottom surface of the base. A plurality of wheels are affixed to the bottom surface of the base. A tube configured to direct the drainage of water that flows through the aperture is attached to the bottom surface of the base. The tube has a curve that redirects the water out and away from a side of the flower pot saucer. The flower pot saucer is both easily transpositioned and allows for proper water drainage.

### CROSS REFERENCE TO RELATED APPLICATION

This application claims the benefit of U.S. Provisional Application Ser. No. 62/519,971 filed Jun. 15, 2017.

### BACKGROUND OF THE INVENTION

This invention is directed to a flower pot saucer, and more particularly, a mobile flower pot saucer having a drainage system.

A person trying to maintain a healthy flora display struggles with the lack of drainage and immobility of flower pot saucers. When a flower pot saucer receives too much water, the water can stagnate in the saucer, leading to rotting roots and breeding mosquitoes. Conventional flower saucers often do not drain properly, either because of the lack of a drainage aperture or lack of elevation of the flower pot saucer from the ground to allow drainage. Additionally, trying to move a conventional flower pot saucer requires dragging the flower pot saucer over the ground or removing the flower pot, moving the flower pot saucer and then replacing the flower pot into the flower pot saucer. This is particularly the case when one is trying to grow healthy flora on a balcony of a high rise and you do not want water to drain on the balcony below. Therefore, needed is a flower pot saucer elevated on wheels with a proper drainage mechanism. In this way, a person trying to maintain a healthy flora display can be assured that overwatering of the flora will not cause the stagnation of water in the flower pot saucer.

An objective of the present invention is to provide a flower pot saucer where the saucer easily and adequately drains water from the flower pot.

Another objective of the present invention is to provide a flower pot saucer that can be easily moved.

These and other objectives will be apparent to those skilled in the art based upon the following written description, drawings, and claims.

### SUMMARY OF THE INVENTION

A saucer for a flower pot with a drainage system has a base with a top surface, a bottom surface, an aperture, and a sidewall that extends upwardly form the outer periphery of the top surface of the base. A screen is associated with the aperture to prevent objects from passing through the aperture.

Connected to or molded with the bottom surface of the base is a drainage tube. The drainage tube has a first end that is axially aligned and in communication with the aperture. Preferably, the first end of the drainage tube has a diameter that is equal to or greater than the diameter of the aperture. The drainage tube narrows as it extends from the first end to a transition point to form a funnel like shape that assists with drainage. The tube has a second end with a diameter smaller than the first end that is adapted to be connected to or coupled with a conventional hose.

Connected to the bottom surface of the base are a plurality of spacing members such as wheels or legs. The spacing members create space for the drainage tube and the wheels provide easy mobility.

### BRIEF DESCRIPTION OF THE DRAWINGS

FIG. 1 is a cross-section view along a central axis of an embodiment of the flower pot saucer;

FIG. 2 is a perspective view of the interior embodiment of the flower pot saucer and a side view of an embodiment of the flower pot saucer;

FIG. 3 is a perspective view of a bottom surface of a base of an embodiment of the flower pot saucer; and

FIG. 4 is a perspective view of an alternate embodiment of the flower pot saucer with a hose attachment.

### DETAILED DESCRIPTION

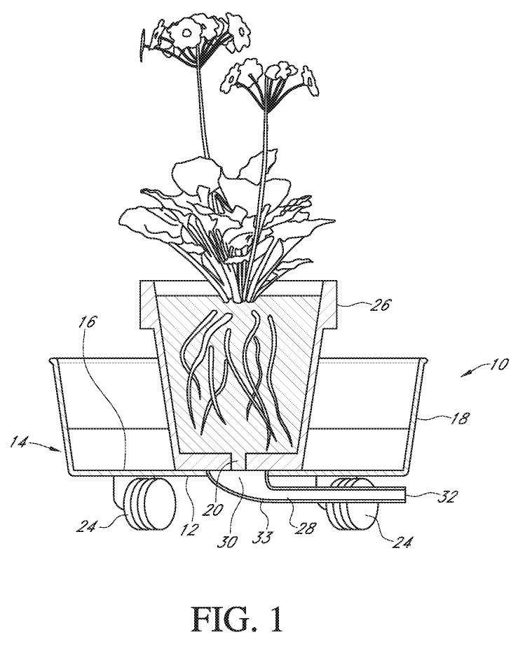

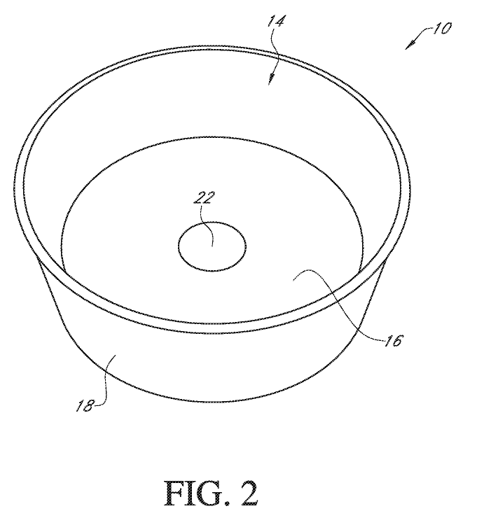

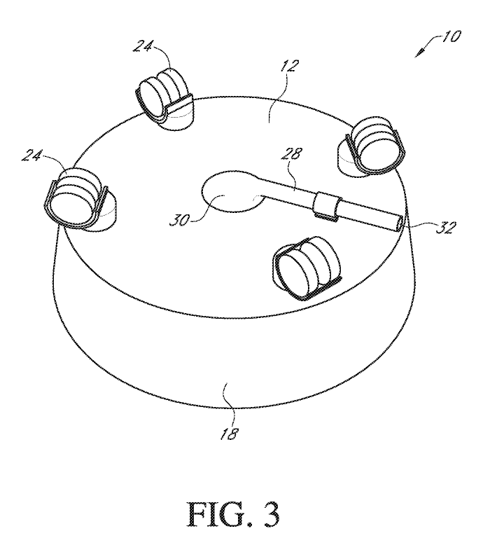

Referring to FIGS. 1-3, there is shown a cross-section view along a central axis of an embodiment of the flower pot saucer 10, a perspective view of the interior embodiment of the flower pot saucer 10 and a side view of an embodiment of the flower pot saucer 10, and a perspective view of a bottom surface 12 of a base 14 of an embodiment of the flower pot saucer 10, respectively. The flower pot saucer 10 comprises a base 14 having a top surface 16 and a bottom surface 12. A sidewall 18 is affixed to the base 14 and extends upwardly therefrom. An aperture 20 is disposed in the base 14. A screen 22 covers the aperture 20 and is affixed to the upper surface 16 of the base 14 along the periphery of the aperture 20. In some embodiments, the screen 22 covers the aperture 20 and is affixed to the bottom surface 12 of the base 14. In yet other embodiments, the screen 22 is disposed on a surface of the base 14 that defines an interior surface of the aperture 20.

A spacing member 24 such as a plurality of wheels or legs affixed to the bottom surface 12 of the base 14. The spacing member 24 creates a space between the bottom surface 12 of the saucer and the ground or floor. The plurality of wheels 24 are configured to allow the flower pot saucer 10 to be moved without lifting the flower pot saucer 10 or a flower pot 26 on the flower pot saucer 10. In the illustrated embodiment, the plurality of wheels 24 are comprised of four wheels that are configured to swivel.

A tube 28 configured to direct the drainage of water that flows through the aperture 20 is attached to the bottom surface 12 of the base 14. The tube 28 has a first open end 30 and a second open end 32. The first open end 30 being axially aligned and in communication with the aperture 20. The tube 28 is curved so that the second open end 32 lies in a generally perpendicular plane to the first open end 30. In the illustrated embodiment, the tube 28 extends out beyond the base 14 of the flower pot saucer 10.

Preferably, the drainage tube 28 and saucer 10 are a molded, one piece construction. Also, in a preferred embodiment, the first end 30 of the drainage tube 28 has a diameter equal to or larger than the diameter of the aperture 20 and narrows as the tube 28 extends toward a transition point 33 to form a funnel like shape. The transition point 33 is where the drainage tube 28 transitions from a generally vertical position to a generally horizontal position. The diameter of the first end 30 is greater than the diameter of the second end 32. The second end 32 is adapted to connect with or be coupled to a conventional elongated hose 36.

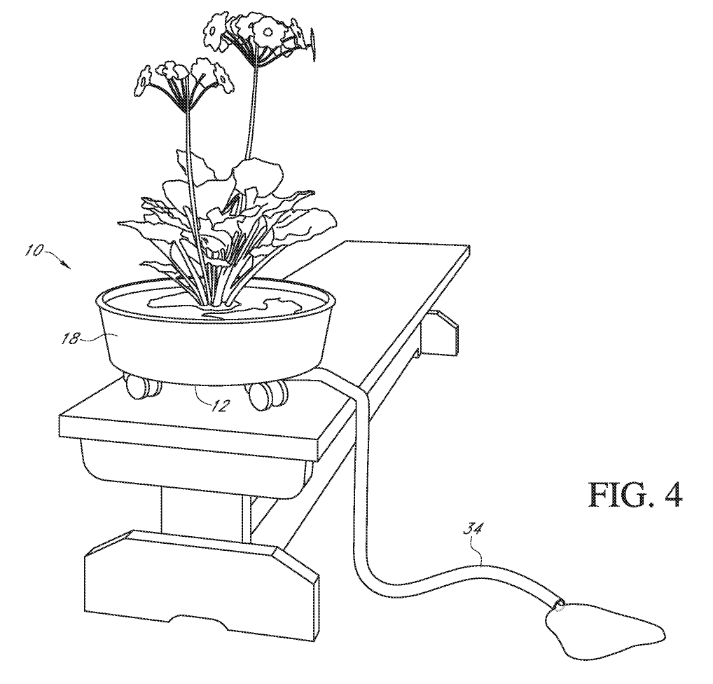

Referring to FIG. 4, there is shown a perspective view of an alternate embodiment of the flower pot saucer 10 with a hose attachment 34. In the illustrated embodiment, the second open end 32 of the tube 28 is configured to attach to a hose 36, further allowing drained water to be removed a distance from the flower pot saucer 10. The plurality of wheels 24 on the bottom allow the flower pot saucer 10 to be easily moved from one location to the next, adjusting for sunlight and other factors.

The flower pot saucer 10 may be composed of ceramic, plastic, or any other suitable material. The flower pot saucer 10 may vary in width and height to accommodate different size flower pots. Thus, exact specifications may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A saucer for a flower pot, comprising:
a base having a top surface and a bottom surface;
a sidewall that extends upwardly from an outer perimeter of the base;
an aperture that extends through the base; and
a drainage tube having a first end in communication with the aperture of the base and a second end that dwells in a plane generally perpendicular to the first end.

2. The saucer of claim 1 further comprising spacing members connected to the bottom surface of the base and the ground surface to create a space.

3. The saucer of claim 2 wherein the spacing members are wheels.

4. The saucer of claim 1 wherein a screen is associated with the aperture and adapted to prevent clogging objects from entering the drain.

5. The saucer of claim 1 wherein the base, sidewall, and tube are molded, one piece construction.

6. The saucer of claim 1 wherein the diameter of the first end of the drainage tube is greater than the diameter of the second end of the drainage tube.
